(19) United States
(12) Patent Application Publication
(10) Pub. No.: US 2026/0255440 A1
(43) Pub. Date: Aug. 27, 2026

(54) METHOD AND DEVICE FOR NEGOTIATING ROLES WITHIN WLAN SYSTEM

(71) Applicant: Samsung Electronics Co., Ltd., Suwon-si (KR)

(72) Inventors: Aniruddh Rao KABBINALE, Bangalore (IN); Anand JEE, Bangalore (IN); Ankur BANSAL, Bangalore (IN)

(21) Appl. No.: 19/529,694

(22) Filed: Feb. 4, 2026

Related U.S. Application Data
(63) Continuation of application No. PCT/KR2026/001633, filed on Jan. 28, 2026.

(30) Foreign Application Priority Data
Feb. 26, 2025 (IN) 202541016904
Aug. 20, 2025 (IN) 2025 41016904

(51) Int. Cl. H04W 84/12

(52) U.S. Cl. CPC H04W 84/12

(57) ABSTRACT

A method performed by a first access point (AP) device in a wireless local area network system comprises transmitting a coordination initiation request message including a preference for a sync reference for at least one of the first AP device and a second AP device, to the second AP device, receiving a coordination response message including one of acceptance of the sync reference in the coordination initiation request message or an updated preference for the sync reference in the coordination initiation request message, from the second AP device, transmitting a coordination agreement message including a refined preference based on the sync reference coordinated for the first AP device and the second AP device provided in the coordination response message, to the second AP device, and receiving a coordination agreement confirmation message indicating one of acceptance or rejection of the coordination agreement message, from the second AP device.

### CROSS-REFERENCE TO RELATED APPLICATION(S)

This application is a continuation application, claiming priority under 35 U.S.C. § 365(c), of an International application No. PCT/KR2026/001633, filed on Jan. 28, 2026, which is based on and claims the benefit of an Indian Provisional patent application number 202541016904, filed on Feb. 26, 2025, in the Indian Patent Office, and of an Indian Complete patent application No. 202541016904, filed on Aug. 20, 2025, in the Indian Patent Office, the disclosure of each of which is incorporated by reference herein in its entirety.

### FIELD OF THE INVENTION

The disclosure relates to the field of wireless communication networks. More particularly, the disclosure relates to a method and system for negotiating roles for carrier frequency offset (CFO) error correction in multi-access point (AP) coordination within wireless local area network (WLAN) systems.

### BACKGROUND

In wireless communication systems, effective coordination among multiple Access Points (APs) within a Basic Service Set (BSS) is used for enhancing network performance and user experience. Multi-AP (MAP) coordination methods, such as Coordinated Joint Transmission (Co-JT) and Coordinated Beamforming (Co-BF), have been developed to optimize data transmission and improve the overall efficiency of wireless networks.

In Coordinated Beamforming (Co-BF), an AP transmits data to its associated stations (STAs) while simultaneously transmitting nulls to STAs in other BSSs to mitigate interference. Similarly, in Coordinated Joint Transmission (Co-JT), multiple APs collaborate to transmit data to one or more STAs concurrently. These methods necessitate precise synchronization of transmissions across different BSSs to ensure coherent data delivery and to maximize the benefits of coordination.

One of the challenges in multi-AP (MAP) coordination is achieving and maintaining frequency synchronization among the APs. The distinct oscillators used by APs and STAs can result in a Center Frequency Offset (CFO), leading to a loss of synchronization. This frequency offset can degrade the performance of coordinated transmission methods, such as Co-JT and Co-BF, by causing misalignment in the transmitted signals.

To address this issue, CFO correction is performed across the BSS. Generally, one AP is designated as the reference for CFO correction, while other APs act as followers, adjusting their center frequencies to align with the reference AP. This correction process often relies on certain transmissions to perform the necessary adjustments and ensure that all APs are frequency synchronized.

However, in scenarios involving multi-AP coordination where multiple BSSs are engaged, there is no singular reference point or device universally accepted for CFO correction. This lack of a standardized reference complicates the synchronization process, potentially leading to suboptimal performance in coordinated transmission methods like Co-BF and JT.

Multi-AP coordination faces synchronization challenges that hinder coordinated joint transmission (Co-JT) and coordinated beamforming (Co-BF) operations. Solutions are needed to provide carrier frequency offset (CFO) correction and frequency synchronization across basic service sets (BSSs), thereby enabling enhanced performance of wireless communication systems.

The above information is presented as background information only to assist with an understanding of the disclosure. No determination has been made, and no assertion is made, as to whether any of the above might be applicable as prior art with regard to the disclosure.

### OBJECT OF THE INVENTION

Aspects of the disclosure are to address at least the above-mentioned problems and/or disadvantages and to provide at least the advantages described below. Accordingly, an aspect of the disclosure is to provide a method and a system for negotiating roles for CFO error correction in Multi-AP Coordination in WLAN systems.

Another aspect of the disclosure is to provide a method for negotiating roles of frequency synchronization reference and frequency synchronization follower among APs included in coordination.

Another aspect of the disclosure is to provide the exchange of capability and preference for taking up the role of frequency synchronization reference and frequency synchronization follower between APs included in coordination.

Another aspect of the disclosure is to provide the exchange of messages to negotiate to take up/assign the role of frequency synchronization reference and frequency synchronization follower between APs included in coordination.

Another aspect of the disclosure is to provide multiple options for assigning sync reference and sync follower.

Another aspect of the disclosure is to provide a method for providing information as part of the negotiation as to which message/transmission should be used as a reference for frequency synchronization across APs/BSSs.

Additional aspects will be set forth in part in the description which follows and, in part, will be apparent from the description, or may be learned by practice of the presented embodiments.

### SUMMARY

In accordance with an aspect of the disclosure, a method performed by a first access point (AP) device in a wireless local area network (WLAN) systems is provided. The method includes transmitting a coordination initiation request message including a preference for a sync reference for at least one of the first AP device and a second AP device, to the second AP device, receiving a coordination response message including one of acceptance of the sync reference in the coordination initiation request message or an updated preference for the sync reference in the coordination initiation request message, from the second AP device, transmitting a coordination agreement message including a refined preference based on the sync reference coordinated for the first AP device and the second AP device provided in the coordination response message, to the second AP device, and receiving a coordination agreement confirmation message indicating one of acceptance or rejection of the coordination agreement message, from the second AP device.

In accordance with an aspect of the disclosure, a method performed by a second access point (AP) device in a wireless local area network (WLAN) system is provided. The method includes receiving a coordination initiation request message including a preference for a sync reference for at least one of a first AP device and the second AP device, from the first AP device, transmitting a coordination response message including one of acceptance of the sync reference in the coordination initiation request message or an updated preference for the sync reference in the coordination initiation request message, to the first AP device, receiving a coordination agreement message including a refined preference based on the sync reference role coordinated for the first AP device and the second AP device provided in the coordination response message, from the first AP device, transmitting a coordination agreement confirmation message indicating one of acceptance or rejection of the coordination agreement message, to the first AP device.

In accordance with an aspect of the disclosure, a first access point (AP) device in a wireless local area network (WLAN) system is provided. The first AP device includes memory storing instructions, and at least one processor operably coupled to the memory, wherein the instructions, when executed by the at least one processor individually or collectively, cause the first AP device to perform operations comprising: transmitting a coordination initiation request message including a preference for a sync reference for at least one of the first AP device and a second AP device, to the second AP device, receiving a coordination response message including one of acceptance of the sync reference in the coordination initiation request message or an updated preference for the sync reference in the coordination initiation request message, from the second AP device, transmitting a coordination agreement message including a refined preference based on the sync reference coordinated for the first AP device and the second AP device provided in the coordination response message, to the second AP device, and receiving a coordination agreement confirmation message indicating one of acceptance or rejection of the coordination agreement message, from the second AP device.

In accordance with an aspect of the disclosure, a second access point (AP) device in a wireless local area network (WLAN) system is provided. The second AP device includes memory storing instructions, and at least one processor operably coupled to the memory, wherein the instructions, when executed by the at least one processor individually or collectively, cause the first AP device to perform operations comprising: receiving a coordination initiation request message including a preference for a sync reference for at least one of a first AP device and the second AP device, from the first AP device, transmitting a coordination response message including one of acceptance of the sync reference in the coordination initiation request message or an updated preference for the sync reference in the coordination initiation request message, to the first AP device, receiving a coordination agreement message including a refined preference based on the sync reference role coordinated for the first AP device and the second AP device provided in the coordination response message, from the first AP device, transmitting a coordination agreement confirmation message indicating one of acceptance or rejection of the coordination agreement message, to the first AP device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 is a schematic diagram that includes a block diagram of a first AP device according to an embodiment of the disclosure;

FIG. 2 is a schematic diagram that includes a schematic of a second AP device according to an embodiment of the disclosure;

FIG. 3 is a sequence diagram that illustrates a role negotiation exchange between the first AP device and the second AP device according to an embodiment of the disclosure;

FIG. 4 is a sequence diagram that illustrates the sequential sounding-based Co-BF operation according to an embodiment of the disclosure;

FIG. 5 is a sequence diagram that illustrates the joint sounding-based Co-BF operation according to an embodiment of the disclosure;

FIG. 6 is a flowchart that illustrate a method for negotiating roles for CFO error correction in MAP coordination by the first AP device according to an embodiment of the disclosure;

FIG. 7 is a flowchart that illustrates the sequential sounding-based Co-BF operation according to an embodiment of the disclosure;

FIG. 8 is a flowchart that illustrates a method for the joint sounding-based Co-BF operation according to an embodiment of the disclosure; and

FIG. 9 is a flowchart that illustrates a method for negotiating roles for CFO error correction in MAP coordination by the second AP device according to an embodiment of the disclosure.

Throughout the drawings, it should be noted that like reference numbers are used to depict the same or similar elements, features, and structures.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Also, the various embodiments described herein are not necessarily mutually exclusive, as embodiments can be combined with one or more other embodiments to form new embodiments. The term “or” as used herein, refers to a non-exclusive or, unless otherwise indicated.

Embodiments may be described using blocks that perform specific functions. These blocks, referred to as managers, units, modules, hardware components, etc., are implemented using analog and/or digital circuits such as logic gates, integrated circuits, microprocessors, microcontrollers, memory circuits, passive and active electronic components, optical components, hardwired circuits, etc., and may be driven by firmware and software. These circuits can be embodied in semiconductor chips or on substrates like printed circuit boards. Blocks can be implemented with dedicated hardware, processors (e.g., programmed microprocessors and associated circuitry), or a combination of both. Each block may be divided into multiple interacting discrete blocks or combined into complex blocks without departing from the scope of the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

The disclosure provides a method to negotiate roles for frequency synchronization or CFO correction between APs in multi-AP coordination. There is also a need to define the reference transmissions to be used for such CFO correction.

In an embodiment, the disclosure sets up a message exchange as part of Co-BF setup/agreement for role negotiation and assignment for frequency synchronization between multiple APs included in multi-AP coordination. The existing mechanism provides the concept of frequency sync reference and follower APs. The proposed solution outlines the message exchanges required for role negotiation of sync reference and sync follower. It specifies exchanges for the assignment of roles between the APs and also provides the exchange of capability and preferences for taking up roles.

In an embodiment, the proposed solution provides reference messages/transmissions from the reference device that need to be used for frequency synchronization.

In another embodiment, the proposed solution describes a method to negotiate roles of frequency synchronization reference and frequency synchronization follower among APs included in coordination. It details the exchange of capability and preference for taking up the role of frequency synchronization reference and frequency synchronization follower between APs included in coordination. It also provides the exchange of messages to negotiate and assign the role of frequency synchronization reference and frequency synchronization follower between APs included in coordination, offering multiple options for assigning sync reference and sync follower.

In an embodiment, the proposed solution provides a method to indicate which message/transmission should be used as a reference for frequency synchronization across APs/BSSs as part of the negotiation.

In the context of Co-BF or Coordinated spatial reuse (Co-SR), the AP that initiates the multi-AP coordination is termed the initiator AP, while the one responding to such coordination is called the responding AP. The initiating AP can also be referred to as the coordinator AP, while the responding AP can be called the coordinating AP. The Co-BF agreement is established after negotiation between initiator and responder APs.

In an embodiment, the Co-BF transmissions have two major phases: the sounding phase and the transmission phase. During the transmission phase, the AP that owns the Transmission Opportunity (TXOP) is called the sharing AP, while the AP allowed to Co-BF transmission during the sharing AP's TXOP is termed the shared AP. The device whose reference transmission is used for CFO correction is called the sync reference, while the device correcting the frequency is called the sync follower.

The proposed solution provides multiple possible ways of choosing which AP needs to be the sync reference and which AP needs to be the sync follower.
Choice 1: The initiator AP acts as the sync reference or sync follower, while the responder AP takes up the other role among sync follower/sync reference.
Choice 2: The sharing AP acts as the sync reference or sync follower, while the shared AP takes up the other role among sync follower/sync reference.
Choice 3: During sounding, certain transmissions are defined as references for pre-correction. The AP transmitting those frames would take up the role of sync reference, while the other AP assumes the role of sync follower.

In an embodiment, the roles may change between phases of sounding and transmission. In Choice 3, the roles change even within the sounding phase of operation.

As part of the negotiation for preference, the following is proposed: To indicate preference during negotiation on the preferred role between being sync reference and sync follower. The preference of role can differ for the sounding phase and the Transmission (Tx) phase. Preference can also indicate if Choice 3 is to be used, where the role changes depending on the reference transmission for pre-correction and the AP transmitting the frame. The AP transmitting the reference frame will be the Sync reference AP, while the one using it to pre-correct the subsequent transmission is the Sync follower.

In an embodiment, if there is no explicit indication, it is assumed that the AP is capable of taking up either role of sync reference or sync follower. It is assumed that in the sounding phase, the role is based on reference Tx, with a Null Data Packet Announcement (NDPA) used as the reference Tx. It is also assumed that the preference would be for the sharing AP to take up the role of sync reference, and the shared AP would assume the role of sync follower during the transmission phase.

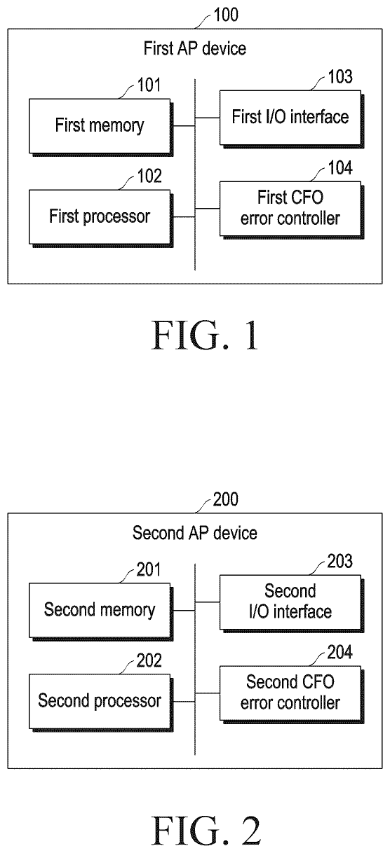

Referring now to the drawings, and more particularly to FIGS. 1 to 9, where similar reference characters denote corresponding features consistently throughout the figures, there are shown embodiments.

FIG. 1 is a schematic diagram showing a block diagram of a first AP device (100) according to an embodiment of the disclosure.

The first AP device (100) may also be referred to as a shared AP, sharing AP, initiator AP, or responder AP. Examples include Consumer Electronics (e.g., Mobile Phones, Smartphones), Tablets, Wearable Devices, Computing Devices (e.g., Laptops, Notebooks, Desktops, Workstations), internet of things (IoT) Devices, Automotive Systems (e.g., connected cars, Autonomous Vehicles, vehicle-to-everything (V2X) communication devices), Enterprise Devices (e.g., robotics), Specialized Equipment (e.g., Medical Devices, Public Safety Devices), and Media Devices (e.g., Gaming Consoles, Streaming Devices).

Referring to FIG. 1, the first AP device (100) includes first memory (101), a first processor (102), a first input/output (I/O) interface (103), and an innovative hardware controller such as a first CFO error correction controller (104). The first memory (101) stores instructions for the processor and may include non-volatile storage elements like magnetic hard disks, optical discs, floppy disks, flash memories, erasable programmable read-only memory (EPROM), or electrically EPROM (EEPROM). It is considered a non-transitory storage medium, meaning it is not embodied in a carrier wave or propagated signal but can store data that changes over time, such as in random access memory (RAM) or cache. When the instructions are executed by the first processor (102), the instructions may cause the first AP device (100) to be operated as described herein.

The first processor (102) can be a single or multiple processors, including general-purpose processors (CPU or AP), graphics processors (GPU) or vision processing unit (VPU), and AI-dedicated processors (NPU). It may have multiple cores to execute instructions stored in the memory. The first memory (101) stores preferences for sync reference roles during sounding and transmission phases, coordination response messages from the second AP device, and coordination agreement proposals (or messages)/confirmations. It includes various computer-readable storage media and non-volatile storage elements, such as magnetic hard disks, optical disks, floppy disks, flash memories, EPROM, or EEPROM.

The first I/O interface (103) transmits information between the first memory (101) and external peripheral devices of the first AP device (100). The first CFO error controller (104) facilitates data transfer and communication between the first I/O interface (103) and the first memory (101), enabling role negotiation of AP devices for CFO error corrections.

In an embodiment, the first CFO error correction controller (104) features a multi-core architecture optimized for tasks such as generating coordination initiation request messages with sync reference role preferences, proposing coordination agreements, and correcting CFO errors based on the AP devices' sync reference roles. The first CFO error correction controller (104) combines analog and digital components, including a low-noise amplifier, a high-precision analog-to-digital converter, a microcontroller unit (MCU), and a digital signal processor (DSP), all designed to support role negotiation of AP devices for CFO error corrections.

TABLE 1
Table 1: Indication of preference for role assignment for sync

| | Preference for role | Preference for |
|---|---|---|
| Preference for role | in transmission | Reference |
| in Sounding phase | phase | Transmission |
| Option 1: Sync | Option 1: Sharing | Option 1: NDPA in |
| reference | AP to become | sounding phase and |
| Option 2: Sync | sync reference | Co-BF trigger in |
| follower | Option 2: Follow | Transmission phase |
| Option 3: Role | the preference | are reference |
| based on | mentioned in | Transmission. |
| Reference | “Preference for | Option 2: All |
| Transmission | role in Sounding | Transmission |
| | phase” | |

TABLE 2
Table 2: Indication of role assignment for sync

| Role in Sounding | Role in transmission | Reference |
|---|---|---|
| phase | phase | Transmission |
| Option 1: Sync | Option 1: Sharing | Option 1: 1^{st} |
| reference for initiator | AP to become sync | NDPA in |
| AP, Sync follower for | reference | sounding |
| Responder AP | Option 2: Follow | phased and Co- |
| Option 2: Sync | the preference | BF trigger in |
| follower for initiator | mentioned in | Transmission |
| AP, Sync reference | “Preference for | phase |
| for responder AP. | role in Sounding | Option 2: All |
| Option 3: Role based | phase” | Transmission |
| on Reference | | |
| Transmission. | | |

In an embodiment, the first CFO error correction controller (104) generates a coordination initiation request message. This coordination initiation request message includes a preference for a sync reference role of the first AP device (100) and a second AP device (200) during a sounding phase and a transmission phase. The coordination initiation request message includes a first option, a second option, and a third option for the sync reference role in the sounding phase to obtain a sounding sync reference. The first option mentions the first AP device (100) as a sync reference, the second option mentions the second AP device (200) as a sync reference, and the third option provides transmissions as a reference for pre-correction during the sounding phase. Additionally, the coordination initiation request message includes a first transmission option and a second transmission option for the sync reference role in the transmission phase to obtain a transmission sync reference. The first transmission option mentions the first AP device (100) or the second AP device (200) as a sync reference, and the second transmission option follows the sounding sync reference obtained for the sounding phase. In the first transmission option, the first AP device or the second AP device shall be the sharing AP. For example, the coordination initiation request message can include parameters such as timing offsets, frequency offsets, and phase noise characteristics to ensure precise synchronization between the AP devices.

The coordination initiation request message is transmitted to the second AP device (200). Upon receiving the coordination initiation request message, a coordination response message is received from the second AP device (200). This coordination response message includes either acceptance of the sync reference role as indicated in the coordination initiation request message or an updated preference for the sync reference role of the first AP device (100) and the second AP device (200) as mentioned in Table 1.

Upon receiving the coordination response message, a coordination agreement proposal (or message) is generated and transmitted to the second AP device (200). This coordination agreement proposal includes a refined preference based on the sync reference role of the first AP device (100) and the second AP device (200) provided in the coordination response message. The first CFO error correction controller (104) adds a first sounding option, a second sounding option, and a third sounding option for the sync reference role in the sounding phase to obtain a final sounding sync reference. Table 2 provides the indication of role assignment. The first sounding option mentions the first AP device (100) as a sync reference and the second AP device (200) as a sync follower, the second sounding option mentions the first AP device (100) as the sync follower and the second AP device (200) as the sync reference, and the third sounding option provides transmissions as a reference for pre-correction during the sounding phase. The coordination agreement proposal also includes a first transmission phase option and a second transmission phase option for the sync reference role in the transmission phase to obtain a final transmission sync reference. The first transmission phase option mentions the first AP device (100) or the second AP device (200) as a sync reference, and the second transmission phase option follows the final sounding sync reference obtained for the sounding phase. In the first transmission phase option, the first AP device (100) or the second AP device (200) shall be the sharing AP.

A coordination agreement confirmation is received from the second AP device (200). This coordination agreement confirmation indicates either acceptance or rejection of the coordination agreement proposal. The CFO error is corrected based on the sync reference role of the first AP device (100) and the second AP device (200) as included in the coordination agreement proposal. If the agreement is accepted, the first CFO error correction controller (104) initiates the synchronization process, adjusting the frequency and phase parameters of the AP devices accordingly. In case of rejection, the first AP device (100) may generate a revised coordination agreement proposal or initiate alternative synchronization methods to achieve the desired error correction.

FIG. 2 is a schematic diagram of a second AP device (200) according to an embodiment of the disclosure.

The second AP device (200) may be called a shared AP, sharing AP, initiator AP, or responder AP. Examples of the first AP device (100) include Consumer Electronics (e.g., Mobile Phones, Smartphones), Tablets, Wearable Devices, Computing Devices (e.g., Laptops, Notebooks, Desktops, Workstations), IoT Devices, Automotive Systems (e.g., connected cars, Autonomous Vehicles, V2X communication devices), Enterprise Devices (e.g., robotics), Specialized Equipment (e.g., Medical Devices, Public Safety Devices), and Media Devices (e.g., Gaming Consoles, Streaming Devices).

Referring to FIG. 2, the second AP device (200) comprises second memory (201), a second processor (202), a second I/O interface (203), and an innovative hardware controller (204) like a second CFO error correction controller. The second memory (201) stores preferences for the sync reference role of the first AP device (100) and the second AP device (200) during sounding and transmission phases, the coordination initiation message from the first AP device (100), and the coordination agreement proposal/confirmation. The second memory (201) stores instructions for the processor and includes both volatile and non-volatile storage media, such as magnetic hard disks, optical disks, floppy disks, flash memories, EPROM, and EEPROM. When the instructions are executed by the second processor (202), the instructions may cause the second AP device (200) to be operated as described herein.

The second I/O interface (203) transmits information between the second memory (201) and external peripheral devices of the second AP device (200). The second CFO error controller (204) interfaces with the second I/O interface (203) and the second memory (201). Coupled with the second memory (201) and the second processor (202), this setup enables the second CFO error controller (204) to facilitate role negotiation of AP devices for CFO error corrections.

The second CFO error correction controller (204) is an advanced integrated circuit with a multi-core architecture for negotiating roles of AP devices in CFO error corrections. Each core is optimized for specific tasks, including generating coordination response messages (accepting the role preference of the first AP device (100) or containing the sync reference role preference of the second AP device (200)), generating coordination agreement confirmations, and correcting CFO errors based on the sync reference roles of the AP devices. The circuit integrates analog components (low-noise amplifier and high-precision analog-to-digital converter) for signal processing and digital components (microcontroller unit (MCU) and digital signal processor (DSP)) for role negotiation and CFO error corrections.

The second CFO error correction controller (204) receives a coordination initiation request message from a first AP device (100). This message includes a preference for a sync reference role of the first AP device (100) and the second AP device (200) as mentioned in Table 1 during the sounding phase and the transmission phase. In response, the second CFO error correction controller (204) generates a coordination response message. This message includes at least one of acceptance of the sync reference role preference provided in the coordination initiation request message or an updated preference for the sync reference role of the first AP device (100) and the second AP device (200). The coordination response message includes a first option, a second option, and a third option for the sync reference role in the sounding phase to obtain a sounding sync reference. The indication of preference for role assignment in the sounding phase is shown in Table 1. The first option mentions the first AP device (100) as a sync reference, the second option mentions the second AP device (200) as a sync reference, and the third option provides transmissions as a reference for pre-correction during the sounding phase. The coordination response message also includes a first transmission option and a second transmission option for the sync reference role in the transmission phase to obtain a transmission sync reference. The indication for role assignment in the transmission phase is shown in Table 1. The first transmission option mentions the first AP device (100) or the second AP device (200) as a sync reference, and the second transmission option follows the sounding sync reference obtained for the sounding phase. In the first transmission option, the first AP device or the second AP device shall be the sharing AP.

Further, a coordination agreement proposal is received from the first AP device (100). This proposal includes a refined preference based on the preference for the sync reference role of the first AP device (100) and the second AP device (200) provided in the coordination response message. In response, the second CFO error correction controller (204) generates a coordination agreement confirmation either accepting or rejecting the coordination agreement proposal. A sequential sounding-based Co-BF operation or a joint sounding-based Co-BF operation is performed upon generation of the coordination agreement proposal. These operations are performed for correcting the CFO error based on the sync reference role of the first AP device (100) and the second AP device (200) included in the coordination agreement proposal.

After the coordination agreement proposal is accepted, the first AP device (100) and the second AP device (200) take on their respective synchronization reference roles for the sounding and transmission phases. In sequential sounding-based Co-BF operation, the devices follow a defined transmit-receive order, enabling step-by-step CFO error correction. In joint sounding-based Co-BF operation, both devices transmit at the same time and use real-time techniques to correct CFO errors. This helps maintain data consistency and reduce network delays. The system can also adjust the synchronization reference roles when network conditions or device performance change. For example, if the first AP device (100) experiences higher interference or movement, the second CFO error correction controller (204) triggers a new coordination cycle to reassign roles. The devices exchange coordination messages and confirmations, enabling CFO error correction to adapt to network changes.

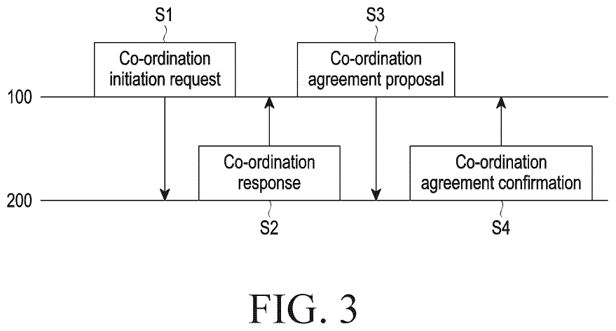

FIG. 3 is a sequence diagram illustrating a role negotiation exchange between the first AP device (100) and the second AP device (200) according to an embodiment of the disclosure.

The sequence diagram shows the first AP device (100) and the second AP device (200) in communication with each other. Each operation is explained below.

Referring to FIG. 3, at operation S1, the first AP device (100) transmits a coordination initiation request to the second AP device (200). The coordination initiation request message includes a preference for a sync reference role of the first AP device (100) and the second AP device (200) during a sounding phase and a transmission phase as mentioned in Table 1. This operation sets the foundation for the negotiation phase, making sure both devices are clear on their roles and expectations. The synchronization reference role keeps the devices in sync, which is necessary for data transmission and reception.

At operation S2, the second AP device (200) transmits a coordination response message to the first AP device (100). The coordination response message includes either acceptance of the sync reference role as indicated in the coordination initiation request message or an updated preference of the second AP device (200) for the sync reference role of the first AP device (100) and the second AP device (200) as mentioned in Table 1. This operation includes a negotiation where the second AP device (200) can either agree with the proposed roles or suggest changes based on its operational needs or limitations. Updating preferences helps the devices reach an agreement that works for both sides.

At operation S3, a coordination agreement proposal is generated by the first AP device (100) and transmitted to the second AP device (200). The coordination agreement proposal includes a refined preference based on the sync reference role as mentioned in Table 2 of the first AP device (100) and the second AP device (200) provided in the coordination response message. This operation includes a negotiation where the first AP device (100) considers the feedback from the second AP device (200) and adjusts its proposal. This refinement ensures the final agreement matches both devices' operational needs.

At operation S4, a coordination agreement confirmation is transmitted from the second AP device (200) to the first AP device (100). The coordination agreement confirmation indicates either acceptance or rejection of the coordination agreement proposal. The CFO error is corrected based on the sync reference role of the first AP device (100) and the second AP device (200) as included in the coordination agreement proposal. This operation concludes the negotiation process, with the second AP device (200) either agreeing to the refined proposal or rejecting it, requiring further negotiation. The correction of the CFO error based on the agreed sync reference role ensures both devices are synchronized, minimizing errors in the communication system.

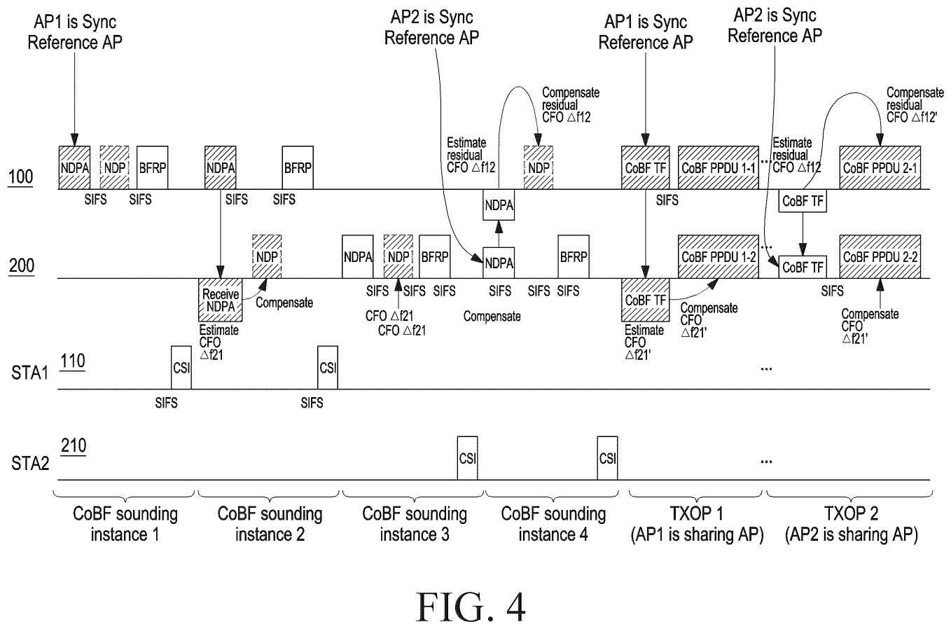

FIG. 4 is a sequence diagram that illustrates the sequential sounding-based Co-BF operation according to an embodiment of the disclosure.

Referring to FIG. 4, during the sounding phase, the NDPA is used as the reference transmission. The AP, either the first AP device (100) or the second AP device (200) transmitting the NDPA, assumes the role of sync reference. The NDPA frame includes information such as the medium access control (MAC) address of the transmitting AP and the intended receiving AP, ensuring proper identification and synchronization. Depending on the reference transmission, the sync reference can be either the first AP device (100) or the second AP device (200). This reference transmission is utilized by the sync follower AP to pre-correct subsequent Co-BF related transmissions such as Null Data Packet (NDP). The pre-correction includes adjusting the phase and amplitude of the transmitted signals to account for any detected discrepancies. In the transmission phase, the Co-BF trigger from the sharing AP is used as a reference for CFO correction. The shared AP corrects the CFO error and performs the Co-BF transmission, ensuring that the transmitted signals are coherently combined at the receiving stations.

The sequential sounding-based Co-BF operation is initiated upon receiving acceptance of the coordination agreement proposal. A null data packet announcement (NDPA) frame is transmitted to the second AP device (200) from the first AP device (100). The NDPA frame indicates that the first station (STA1) (110) is sounded by the first AP device (100), designating the first AP device (100) as the sync reference and the second AP device (200) as the sync follower. The NDPA frame also includes timing information to ensure that the second AP device (200) can follow the synchronization process. Upon sounding of the STA1 (110) by the first AP device (100), a first channel state information (CSI) feedback is received from the STA1. The CSI feedback contains detailed information about the channel characteristics, such as path loss, multipath effects, and Doppler shifts. Subsequently, a second NDPA frame is transmitted from the first AP device (100) to the second AP device (200). This second NDPA frame indicates that the second station (STA2) (210) is sounded by the first AP device (100). Upon sounding of the STA2 (210) by the first AP device (100), a second CSI feedback is received from the STA2. A residual CFO is determined based on the first CSI feedback received from the STA1 (110) and the second CSI feedback received from the STA2 (210). The determined residual CFO is compensated to perform a Co-BF transmission with frequency synchronization between the first AP device (100) and the second AP device (200). This compensation includes fine-tuning the local oscillators of both AP devices to minimize frequency offset and ensure coherent beamforming.

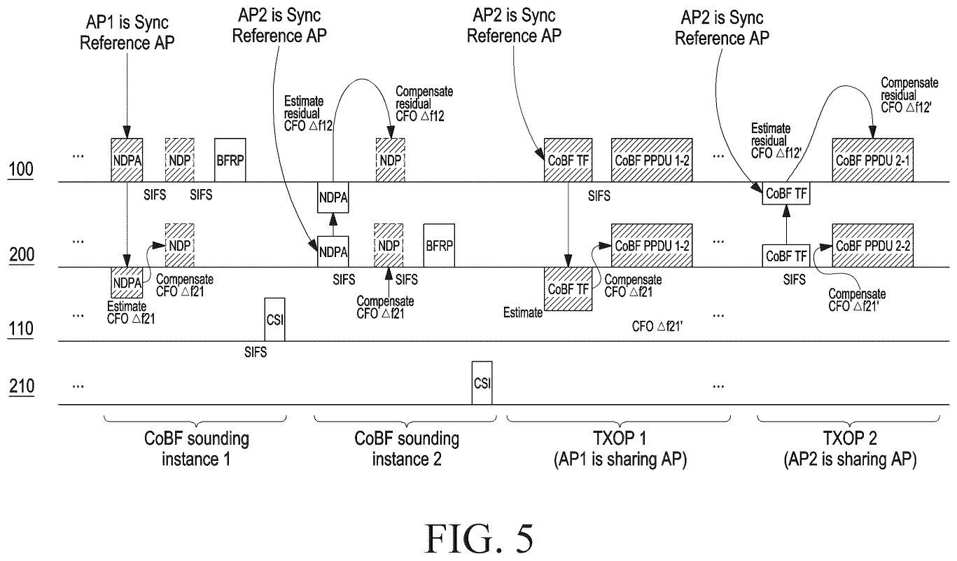

FIG. 5 is a sequence diagram that illustrates the joint sounding-based Co-BF operation according to an embodiment of the disclosure.

Referring to FIG. 5, during the sounding phase, the NDPA is used as the reference transmission. The AP, either the first AP device (100) or the second AP device (200) transmitting the NDPA, assumes the role of sync reference. The NDPA frame includes additional fields for joint sounding, such as the list of participating APs and their respective roles in the sounding process. Depending on the reference transmission, the sync reference can be either the first AP device (100) or the second AP device (200). This reference transmission is utilized by the sync follower AP to pre-correct subsequent Co-BF related transmissions such as Null Data Packet (NDP). The pre-correction process includes calculating the expected signal distortions and applying the necessary adjustments to the transmitted signals. In the transmission phase, the Co-BF trigger from the sharing AP is used as a reference for CFO correction. The shared AP corrects the CFO error and performs the Co-BF transmission, ensuring that the signals from multiple APs are combined constructively at the receiving stations.

The joint sounding-based Co-BF operation is initiated upon receiving acceptance of the coordination agreement proposal. An NDPA frame is transmitted to the second AP device (200) from the first AP device (100). The NDPA frame indicates that at least one of the STA1 (110) associated with the first AP device (100) is sounded by both the first AP device (100) and the second AP device (200), and the STA2 (210) associated with the second AP device (200) is sounded by both the first AP device (100) and the second AP device (200). The NDPA frame also includes synchronization information to ensure that both AP devices can coordinate their sounding operations. The first AP device (100) is designated as the sync reference and the second AP device (200) is the sync follower as the first AP device (100) transmitted the NDPA to the second AP device (200). CSI feedback is received from at least one of the STA1 (110) and the STA2 (210) upon sounding by the first AP device (100) or the second AP device (200). The CSI feedback includes detailed channel measurements that are used to optimize the beamforming process. A residual CFO is determined based on the CSI feedback received from at least one of the STA1 (110) and the STA2 (210). The determined residual CFO is compensated to perform a Co-BF transmission with frequency synchronization between the first AP device (100) and the second AP device (200). This compensation ensures that the transmitted signals from both AP devices are phase-aligned, maximizing the beamforming gain at the receiving stations.

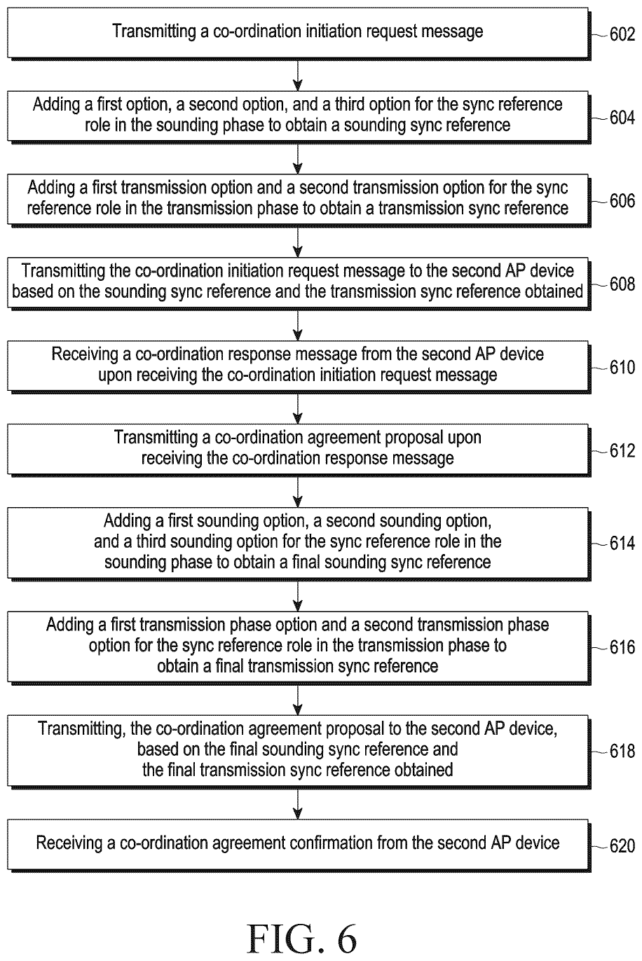

FIG. 6 is a flowchart illustrating a method for negotiating roles for CFO error correction in MAP coordination by the first AP device (100) according to an embodiment of the disclosure.

The method includes operations 602 to 620, each of which is explained in further detail below.

Referring to FIG. 6, at operation 602, the method includes transmitting, by the first AP device (100), a coordination initiation request message. This message includes a preference for a sync reference role of the first AP device (100) and a second AP device (200) during a sounding phase and a transmission phase.

In operation 604, the method includes adding, by the first AP device (100), a first option, a second option, and a third option for the sync reference role in the sounding phase to obtain a sounding sync reference. The indication of preference for role assignment in the sounding phase is shown in Table 1. The first option mentions the first AP device (100) as a sync reference, the second option mentions the second AP device (200) as a sync reference, and the third option provides transmissions as a reference for pre-correction during the sounding phase.

At operation 606, the method includes adding, by the first AP device (100), a first transmission option and a second transmission option for the sync reference role in the transmission phase to obtain a transmission sync reference. The indication for role assignment in the transmission phase is shown in Table 1. The first transmission option mentions the first AP device (100) or the second AP device (200) as a sync reference, and the second transmission option follows the sounding sync reference obtained for the sounding phase. In the first transmission option, the first AP device or the second AP device shall be the sharing AP.

Operation 608 includes transmitting, by the first AP device (100) to the second AP device, the coordination initiation request message based on the sounding sync reference and the transmission sync reference obtained.

In operation 610, the method includes receiving, by the first AP device (100), a coordination response message from the second AP device (200) upon receiving the coordination initiation request message. The coordination response message comprises either acceptance of the sync reference role as indicated in the coordination initiation request message or an updated preference for the sync reference role of the first AP device (100) and the second AP device (200).

At operation 612, the method includes transmitting, by the first AP device (100), a coordination agreement proposal upon receiving the coordination response message. This proposal includes a refined preference based on the sync reference role of the first AP device (100) and the second AP device (200) provided in the coordination response message.

Operation 614, includes adding, by the first AP device (100), a first sounding option, a second sounding option, and a third sounding option for the sync reference role in the sounding phase to obtain a final sounding sync reference. The indication of role assignment is given in Table 2. The first sounding option mentions the first AP device (100) as a sync reference and the second AP device (200) as a sync follower, the second sounding option mentions the first AP device (100) as the sync follower and the second AP device (200) as the sync reference, and the third sounding option provides transmissions as a reference for pre-correction during the sounding phase.

At operation 616, the method includes adding, by the first AP device (100), a first transmission phase option and a second transmission phase option for the sync reference role in the transmission phase to obtain a final transmission sync reference. The indication of role assignment is given in Table 2. The first transmission phase option mentions the first AP device (100) or the second AP device (200) as a sync reference, and the second transmission phase option follows the final sounding sync reference obtained for the sounding phase. In the first transmission phase option, the first AP device (100) or the second AP device (200) shall be the sharing AP.

Operation 618 includes transmitting, by the first AP device (100) to the second AP device, a coordination agreement proposal based on the final sounding sync reference and the final transmission sync reference obtained. At operation 620, the coordination agreement confirmation is received from the second AP device (200). The coordination agreement confirmation indicates either acceptance or rejection of the coordination agreement proposal.

A sequential sounding-based Co-BF operation or a joint sounding-based Co-BF operation is performed based upon the sync reference role of the first AP device (100) and the second AP device (200) included in the coordination agreement proposal. The Co-BF operations are further explained below.

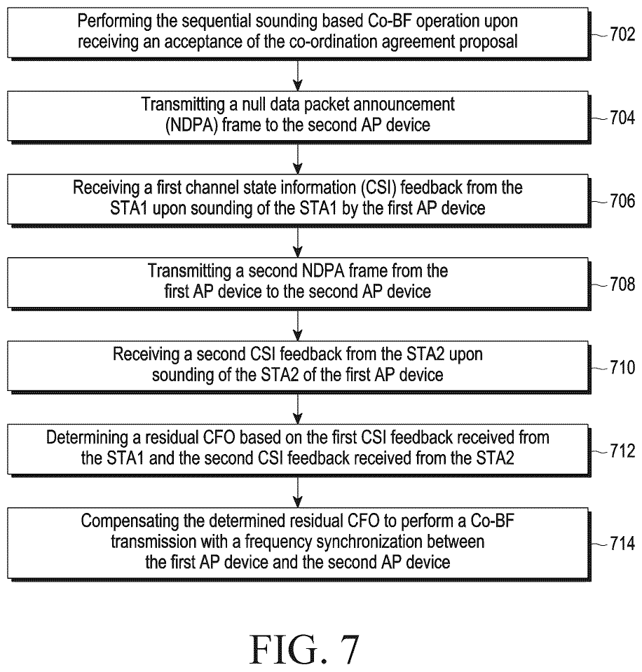

FIG. 7 is a flowchart illustrating the sequential sounding-based Co-BF operation according to an embodiment of the disclosure.

During the sounding phase, the NDPA is used as the reference transmission. The AP, either the first AP device (100) or the second AP device (200), transmitting the NDPA assumes the role of Sync reference. The method includes operations 702 to 714, each of which is explained in further detail below.

Referring to FIG. 7, at operation 702, the method includes performing the sequential sounding-based Co-BF operation upon receiving acceptance of the coordination agreement proposal. In operation 704, a null data packet announcement (NDPA) frame is transmitted from the first AP device (100) to the second AP device (200). This NDPA frame indicates that the STA1 (110) is sounded by the first AP device (100), which acts as a sync reference, while the second AP device (200) is a sync follower.

Receiving a first channel state information (CSI) feedback from the STA1 (110) upon its sounding by the first AP device (100) is included in operation 706. In operation 708, the method includes transmitting a second NDPA frame from the first AP device (100) to the second AP device (200). This second NDPA frame indicates that a second station (STA2) (210) is sounded by the first AP device (100). Operation 710 includes receiving a second CSI feedback from the STA2 (210) upon its sounding by the first AP device (100).

Determining a residual CFO based on the first CSI feedback received from the STA1 (110) and the second CSI feedback received from the STA2 (210) is included in operation 712. Further, operation 714 includes compensating the determined residual CFO to perform a Co-BF transmission with frequency synchronization between the first AP device (100) and the second AP device (200).

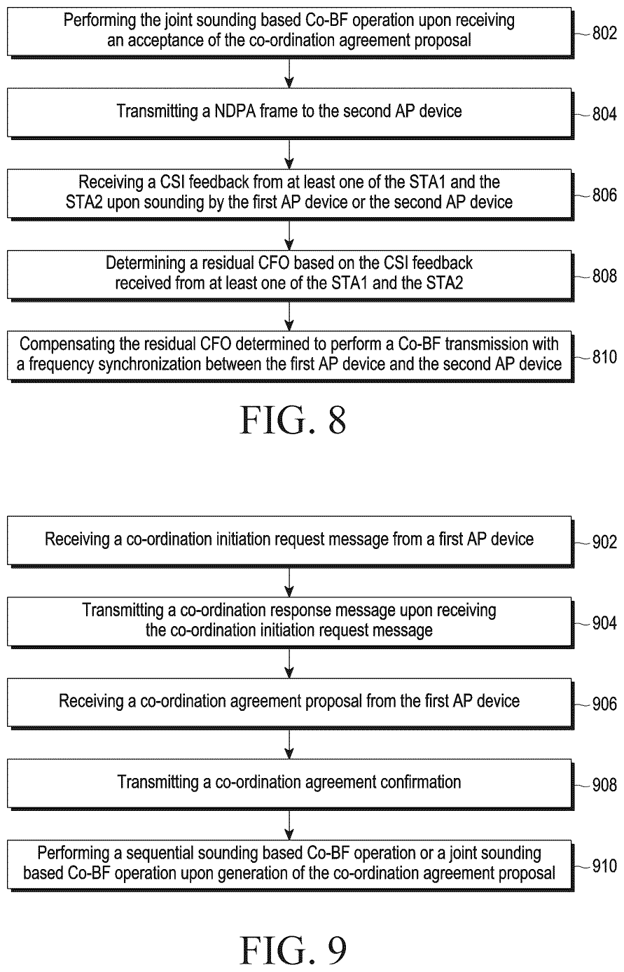

FIG. 8 is a flowchart that illustrates a method for the joint sounding-based Co-BF operation according to an embodiment of the disclosure.

The method includes operations 802 to 810. Each operation is explained in further detail below.

Referring to FIG. 8, at operation 802, the method includes performing, by the first AP device (100), the joint sounding based Co-BF operation upon receiving an acceptance of the co-ordination agreement proposal.

At operation 804, the method includes transmitting, by the first AP device (100), NDPA frame to the second AP device (200).

At operation 806, the method includes receiving, by the first AP device (100), a CSI feedback from at least one of the STA1 and the STA2 upon sounding by the first AP device (100) or the second AP device (200).

At operation 808, the method includes determining, by the first AP device (100), a residual CFO based on the CSI feedback received from at least one of the STA1 and the STA2.

At operation 810, the method includes compensating, by the first AP device (100), the residual CFO determined to perform a Co-BF transmission with a frequency synchronization between the first AP device (100) and the second AP device (200).

FIG. 9 is a flowchart that illustrates a method for negotiating roles for CFO error correction in MAP coordination by the second AP device (200) according to an embodiment of the disclosure.

The method includes operations 902 to 910. Each operation is explained in further detail below.

Referring to FIG. 9, at operation 902, the method includes receiving by the second AP device (200) coordination initiation request message from the first AP device (100). The coordination initiation request message includes a preference for a sync reference role of the first AP device (100) and the second AP device (200) in a sounding phase and a transmission phase

At operation 904, the method includes transmitting by the second AP device (200) a coordination response message upon receiving the coordination initiation request message. The coordination response message comprises one of acceptance of the sync reference role provided in the coordination initiation request message or an updated preference for the sync reference role of the first AP device (100) and the second AP device (200).

At operation 906, the method includes receiving by the second AP device a coordination agreement proposal from the first AP device (100). The coordination agreement proposal includes a refined preference based on the preference for the sync reference role of the first AP device (100) and the second AP device (200) provided in the coordination response message. At operation 908, the method includes transmitting a coordination agreement confirmation either accepting or rejecting the coordination agreement proposal.

At operation 910, the method includes performing a sequential sounding based Co-BF operation or a joint sounding based Co-BF operation, upon generation of the coordination agreement proposal. The sequential sounding based Co-BF operation and the joint sounding based Co-BF operation are performed for correcting the CFO error based on the sync reference role of the first AP device (100) and the second AP device (200) included in the coordination agreement proposal.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first access point (AP) device in a wireless local area network (WLAN) system, the method comprising:
transmitting a coordination initiation request message including a preference for a sync reference for at least one of the first AP device and a second AP device, to the second AP device;
receiving a coordination response message including one of acceptance of the sync reference in the coordination initiation request message or an updated preference for the sync reference in the coordination initiation request message, from the second AP device;
transmitting a coordination agreement message including a refined preference based on the sync reference coordinated for the first AP device and the second AP device provided in the coordination response message, to the second AP device; and
receiving a coordination agreement confirmation message indicating one of acceptance or rejection of the coordination agreement message, from the second AP device.

2. The method of claim 1, further comprising:
correcting a carrier frequency offset (CFO) error based on the sync reference coordinated for the first AP device and the second AP device in the coordination agreement message.

3. The method of claim 2, wherein correcting the CFO error comprises:
performing a sequential sounding based coordinated beamforming (Co-BF) operation or a joint sounding based Co-BF operation upon receiving an acceptance of the coordination agreement message,
wherein the sequential sounding based Co-BF operation and the joint sounding based Co-BF operation are performed for correcting the CFO error based on the sync reference coordinated for the first AP device and the second AP device included in the coordination agreement message.

4. The method of claim 1, wherein transmitting the coordination initiation request message comprises:
adding a first option, a second option, and a third option for the sync reference in a sounding phase to obtain a sounding sync reference,
wherein the first option mentions the first AP device as the sync reference,
wherein the second option mentions the second AP device as the sync reference, and
wherein the third option provides transmissions as a reference for pre-correction during the sounding phase;
adding a first transmission option and a second transmission option for the sync reference in a transmission phase to obtain a transmission sync reference,
wherein the first transmission option mentions the first AP device or the second AP device as the sync reference, and
wherein the second transmission option follows the sounding sync reference obtained for the sounding phase; and
generating the coordination initiation request message based on the obtained sounding sync reference and the obtained transmission sync reference.

5. The method of claim 1, wherein transmitting the coordination agreement message comprises:
adding a first sounding option, a second sounding option, and a third sounding option for the sync reference in a sounding phase to obtain a final sounding sync reference,
wherein the first sounding option mentions the first AP device as the sync reference and a second AP device as a sync follower,
wherein the second sounding option mentions the first AP device as the sync follower and the second AP device as the sync reference, and
wherein the third sounding option provides transmissions as a reference for pre-correction during the sounding phase;
adding a first transmission phase option and a second transmission phase option for the sync reference in the transmission phase to obtain a final transmission sync reference,
wherein the first transmission phase option mentions the first AP device or the second AP device as the sync reference, and
wherein the second transmission phase option follows the final sounding sync reference obtained for the sounding phase; and
generating the coordination agreement proposal based on the obtained final sounding sync reference and the obtained final transmission sync reference.

6. The method of claim 3, wherein performing the sequential sounding based Co-BF operation comprises:
transmitting a null data packet announcement (NDPA) frame to the second AP device,
wherein the NDPA frame indicates that a first station (STA1) is sounded by the first AP device, and
wherein the first AP device is the sync reference and the second AP device is a sync follower;
receiving a first channel state information (CSI) feedback from the STA1 upon sounding of the STA1 by the first AP device;
transmitting a second NDPA frame from the first AP device to the second AP device, wherein the second NDPA frame indicates that a second station (STA2) is sounded by the first AP device;
receiving a second CSI feedback from the STA2 upon sounding of the STA2 of the first AP device;
determining a residual CFO based on the first CSI feedback received from the STA1 and the second CSI feedback received from the STA2; and
compensating the residual CFO determined to perform a Co-BF transmission with a frequency synchronization between the first AP device and the second AP device.

7. The method of claim 3, wherein performing the joint sounding based Co-BF operation comprises:
transmitting a null data packet announcement (NDPA) frame to the second AP device,
wherein the NDPA frame indicates at least one of, a STA1 associated with the first AP device is sounded by both the first AP device and the second AP device, and a STA2 associated with the second AP device is sounded by both the first AP device and the second AP device, and
wherein the first AP device is the sync reference and the second AP device is a sync follower;
receiving a CSI feedback from at least one of the STA1 and the STA2 upon sounding by the first AP device or the second AP device;
determining a residual CFO based on the CSI feedback received from at least one of the STA1 and the STA2; and
compensating the residual CFO determined to perform a Co-BF transmission with a frequency synchronization between the first AP device and the second AP device.

8. The method of claim 1, wherein the refined preference in the coordination agreement message is based on predefined criteria for determining the sync reference coordinated for the first AP device and the second AP device.

9. A method performed by a second access point (AP) device in a wireless local area network (WLAN) system, the method comprising:
receiving a coordination initiation request message including a preference for a sync reference for at least one of a first AP device and the second AP device, from the first AP device;
transmitting a coordination response message including one of acceptance of the sync reference in the coordination initiation request message or an updated preference for the sync reference in the coordination initiation request message, to the first AP device;
receiving a coordination agreement message including a refined preference based on the sync reference coordinated for the first AP device and the second AP device provided in the coordination response message, from the first AP device;
transmitting a coordination agreement confirmation message indicating one of acceptance or rejection of the coordination agreement message, to the first AP device.

10. The method of claim 9, further comprising:
performing a sequential sounding based coordinated beamforming (Co-BF) operation or a joint sounding based Co-BF operation based on the coordination agreement message,
wherein the sequential sounding based Co-BF operation and the joint sounding based Co-BF operation are performed for correcting a carrier frequency offset, CFO, error based on the sync reference coordinated for the first AP device and the second AP device included in the coordination agreement message.

11. The method of claim 10, wherein performing the sequential sounding based Co-BF operation comprises:
transmitting a null data packet announcement (NDPA) frame to the first AP device,
wherein the NDPA frame indicates that a first station (STA1) is sounded by the second AP device, and
wherein the second AP device is the sync reference and the first AP device is a sync follower;
receiving a first channel state information (CSI) feedback from the STA1 upon sounding of the STA1 by the second AP device;
transmitting a second NDPA frame from the second AP device to the first AP device, wherein the second NDPA frame indicates that a second station (STA2) is sounded by the second AP device;
receiving a second CSI feedback from the STA2 upon sounding of the STA2 of the second AP device;
determining a residual CFO based on the first CSI feedback received from the STA1 and the second CSI feedback received from the STA2; and
compensating the residual CFO determined to perform a Co-BF transmission with a frequency synchronization between the first AP device and the second AP device.

12. The method of claim 10, wherein performing the joint sounding based Co-BF operation comprises:
transmitting a null data packet announcement (NDPA) frame to the first AP device,
wherein the NDPA frame indicates at least one of, a STA1 associated with the first AP device is sounded by both the first AP device and the second AP device, and a STA2 associated with the second AP device is sounded by both the first AP device and the second AP device, and
wherein the second AP device is the sync reference and the first AP device is a sync follower;
receiving a CSI feedback from at least one of the STA1 and the STA2 upon sounding by the second AP device;
determining a residual CFO based on the CSI feedback received from at least one of the STA1 and the STA2; and
compensating the residual CFO determined to perform a Co-BF transmission with a frequency synchronization between the first AP device and the second AP device.

13. A first access point (AP) device in a wireless local area network (WLAN) system, the first AP device comprising:
memory storing instructions; and
at least one processor operably coupled to the memory, wherein the instructions, when executed by the at least one processor individually or collectively, cause the first AP device to perform operations comprising:
transmitting a coordination initiation request message including a preference for a sync reference for at least one of the first AP device and a second AP device, to the second AP device;
receiving a coordination response message including one of acceptance of the sync reference in the coordination initiation request message or an updated preference for the sync reference in the coordination initiation request message, from the second AP device;
transmitting a coordination agreement message including a refined preference based on the sync reference coordinated for the first AP device and the second AP device provided in the coordination response message, to the second AP device; and
receiving a coordination agreement confirmation message indicating one of acceptance or rejection of the coordination agreement message, from the second AP device.

14. The first AP device of claim 13, wherein the operations further comprise correcting a carrier frequency offset (CFO) error based on the sync reference coordinated for the first AP device and the second AP device in the coordination agreement proposal message.

15. The first AP device of claim 14, wherein correcting the CFO error comprises:
performing a sequential sounding based coordinated beamforming (Co-BF) operation or a joint sounding based Co-BF operation upon receiving an acceptance of the coordination agreement message,
wherein the sequential sounding based Co-BF operation and the joint sounding based Co-BF operation are performed for correcting the CFO error based on the sync reference coordinated for the first AP device and the second AP device in the coordination agreement message.

16. The first AP device of claim 13, wherein transmitting the coordination initiation request message comprises:
adding a first option, a second option, and a third option for the sync reference in a sounding phase to obtain a sounding sync reference,
wherein the first option mentions the first AP device as the sync reference,
wherein the second option mentions the second AP device as the sync reference, and
wherein the third option provides transmissions as a reference for pre-correction during the sounding phase;
adding a first transmission option and a second transmission option for the sync reference role in a transmission phase to obtain a transmission sync reference,
wherein the first transmission option mentions the first AP device or the second AP device as the sync reference, and
wherein the second transmission option follows the sounding sync reference obtained for the sounding phase; and
generating the coordination initiation request message based on the obtained sounding sync reference and the obtained transmission sync reference.

17. The first AP device of claim 13, wherein transmitting the coordination agreement message comprises:
adding a first sounding option, a second sounding option, and a third sounding option for the sync reference in a sounding phase to obtain a final sounding sync reference,
wherein the first sounding option mentions the first AP device as the sync reference and a second AP device as a sync follower,
wherein the second sounding option mentions the first AP device as the sync follower and the second AP device as the sync reference, and
wherein the third sounding option provides transmissions as a reference for pre-correction during the sounding phase;
adding a first transmission phase option and a second transmission phase option for the sync reference in the transmission phase to obtain a final transmission sync reference,
wherein the first transmission phase option mentions the first AP device or the second AP device as the sync reference, and
wherein the second transmission phase option follows the final sounding sync reference obtained for the sounding phase; and
generating the coordination agreement proposal based on the obtained final sounding sync reference and the final obtained transmission sync reference.

18. The first AP device of claim 15, wherein performing the sequential sounding based Co-BF operation comprises:
transmitting a null data packet announcement (NDPA) frame to the second AP device,
wherein the NDPA frame indicates that a first station (STA1) is sounded by the first AP device, and
wherein the first AP device is the sync reference and the second AP device is a sync follower;
receiving a first channel state information (CSI) feedback from the STA1 upon sounding of the STA1 by the first AP device;
transmitting a second NDPA frame from the first AP device to the second AP device, wherein the second NDPA frame indicates that a second station (STA2) is sounded by the first AP device;
receiving a second CSI feedback from the STA2 upon sounding of the STA2 of the first AP device;
determining a residual CFO based on the first CSI feedback received from the STA1 and the second CSI feedback received from the STA2; and
compensating the residual CFO determined to perform a Co-BF transmission with a frequency synchronization between the first AP device and the second AP device.

19. The first AP device of claim 15, wherein performing the joint sounding based Co-BF operation comprises:
transmitting a null data packet announcement (NDPA) frame to the second AP device,
wherein the NDPA frame indicates at least one of, a STA1 associated with the first AP device is sounded by both the first AP device and the second AP device, and a STA2 associated with the second AP device is sounded by both the first AP device and the second AP device, and
wherein the first AP device is the sync reference and the second AP device is a sync follower;
receiving a CSI feedback from at least one of the STA1 and the STA2 upon sounding by the first AP device or the second AP device;
determining a residual CFO based on the CSI feedback received from at least one of the STA1 and the STA2; and
compensating the residual CFO determined to perform a Co-BF transmission with a frequency synchronization between the first AP device and the second AP device.

20. The first AP device of claim 13, wherein the refined preference in the coordination agreement message is based on predefined criteria for determining the sync reference coordinated for the first AP device and the second AP device.
